(19) United States
(12) Patent Application Publication
(10) Pub. No.: US 2018/0240305 A1
(43) Pub. Date: Aug. 23, 2018

(54) Methods for Administering Card Games

(71) Applicant: KJL Gaming, LLC, Dewitt, IL (US)

(72) Inventor: Kim J. LeBaube, Dewitt, IL (US)

(73) Assignee: KJL Gaming, LLC, Dewitt, IL (US)

(21) Appl. No.: 15/436,741

(22) Filed: Feb. 17, 2017

(51) Int. Cl. G07F 17/32; A63F 1/00

(52) U.S. Cl. CPC G07F 17/3293; A63F 2001/005; G07F 17/3223; A63F 1/00

(57) ABSTRACT

This invention relates generally to a card game wherein a player selects a new card from a pile of open-faced cards to complete a hand. Preferably, the game is implemented in even rounds of card selection so that the order of players selecting cards is reversed every round. In the most preferred embodiment, the card game follows the basic hand ranking of poker and is implemented in conjunction with a series of bets to increase the size of the pot and the player's excitement.

### TECHNICAL FIELD

The disclosure relates generally to a card-based game, and more particularly to a poker game preferably for casinos and other gaming establishments. More specifically, disclosed embodiments relate to methods of administering card games wherein a player may choose one or more cards from a selection of cards faced-up.

### BACKGROUND

Many different poker games presently exist for use in both home and casino environments. Such games should be exciting, uncomplicated, and easy to learn to avoid frustrating players. Poker games have an established ranking of hands and numerous opportunities for the players to wager, thus increasing player participation and excitement. In addition, the games take place relatively quickly, thereby preventing a player's attention from being distracted.

Many single and multiplayer playing card-based games have been devised that require the use of a deck of fifty-two playing cards. The deck consists of cards of four suits, namely, clubs, diamonds, hearts, and spades. Each suit contains thirteen cards which, when ranked in decreasing order, consist of an Ace, King, Queen, Jack, 10, 9, 8, 7, 6, 5, 4, 3, and a 2.

During a conventional card game, a dealer deals each player an initial “hand” or set of cards. The player then reviews his or her hand (without revealing all or a portion of their hand to the other players), discards some or all of his or her cards, and the dealer then gives the player an equal number of cards to replace the cards discarded. This procedure of discarding and replacing cards may occur one or more times, until finally the rules of the particular game requires that all of the players reveal their hands to the other participating players. The winning hand is then determined.

One particular card game is poker The game of poker is conventionally played by a plurality of players who are dealt cards from a deck of fifty-two playing cards. A poker hand typically consists of five or more cards, and has a winning high value or poker rank that is determined by the combinations set forth below, which are ranked in decreasing order based upon the mathematical probability of their occurrence:
A. Royal Flush, consisting of an Ace, King, Queen, Jack, and 10, all of the same suit;
B. Straight Flush, consisting of five cards in ranking sequence, all of the same suit;
C. Four-of-a-Kind, consisting of four cards of the same rank;
D Full House, consisting of three cards of one rank and two cards of another rank;
E. Flush, consisting of five cards of the same suit, not in ranking sequence;
F Straight, consisting of five cards in ranking sequence, not all of the same suit;
G Three-of-a-Kind, consisting of three cards of the same rank;
H. Two Pairs, consisting of two cards of one rank and two cards of another rank;
I. One Pair, consisting of two cards of the same rank.

A hand that does not have any of the above combinations is ranked by the highest-ranking card it contains, as well as the next highest card in decreasing order of rank.

Poker is often played with a deck containing one or two Jokers as a fifty-third and/or fifty-fourth card, and designated as wild (i.e., to represent any card its holder does not have, or to represent an Ace or any card needed to complete a Straight or a Flush). There are also numerous variations of poker with different wild cards and varied payouts and bonuses for different types of hands.

The two basic forms of poker are draw poker and stud poker With each form, each player normally places a bet of a predetermined amount (generally referred to as an “ante”) before any cards are dealt. The ante is basically an entrance fee for each player to receive an initial hand of cards. In the game of draw poker, each player is dealt five cards face down. Each player reviews his or her hand to determine whether to withdraw from the game (generally referred to as “folding”), or to continue participating in the round. Each active or remaining player may then, at his or her option, discard any of his or her cards, and the dealer then gives the player an equal number of cards to replace the cards discarded. This replacement of discarded cards is called the “draw”. The right of each player to discard cards from his or her face-down five-card hand as initially dealt, and to draw the same number of cards as replacements for the discarded cards, is one of the characteristics distinguishing draw poker from stud poker In stud poker, cards are not normally discarded. A second betting round among the remaining players follows, after which there is a “showdown” in which the players' hands are compared with one another to determine which player wins. Conventionally, in both draw poker and stud poker, the player holding the highest-ranking poker hand of all players at the showdown wins.

Many variations in the play of poker-type games have been introduced to increase the excitement and interest in the play of both table and video versions of poker Many of the poker variants are played against a dealer hand. In more traditional forms of poker, a player plays against other players, and a highest-ranking hand wins the round. For example, Texas Hold'Em is a game in which players compete against other players to make a best five-card hand from seven available cards. After the first round of wagering, each player is dealt two cards faced down. After viewing the two cards faced down, each player is given the opportunity to make an additional wager. In some embodiments, the additional wager must at least match the opening bet for the round or the player folds. Five community cards are then dealt faced down. The dealer reveals the first three community cards (also known as “the flop”). Another round of betting takes place. Then the dealer reveals the fourth community card (also known as “the turn” card), and the last round of betting takes place. The dealer then reveals the fifth community card (also known as “the river” card) and compares each player's best five-card hand, comprised of their two face-down cards and the five community cards to determine which player holds the hand with the highest value or poker rank. The winner claims the pot of wagers received from participating players during the game. In some forms of the game, the pot is split amongst the top hands with the highest values. For example, the highest value hand wins 80% of the pot and the second best hand wins 20% of the pot.

Poker has been adopted in various forms to casino play. In one type of casino poker, each player plays against each of the other players seated about a table with all bets being contributed to a pot. In another type of casino poker, each of the players plays against the dealer In this version, the player only wins if the player's hand is superior to the dealer's hand, and the payout is determined by a predetermined formula (i.e., the player is given 1000 to 1 odds that he or she will beat the dealer by way of a royal flush).

Generally, the casino provides the table accommodations along with, in most jurisdictions, a dealer who deals the cards, provides gaming tokens or chips to the players for placing bets, watches the pot to make sure all the players are contributing chips as they should, and compares and announces the winning hands. In return for these services, the casino charges a fee, such as a “rake” (a portion of the pot) or an hourly fee collected from each player.

A casino may also, or in the alternative, provide players with the opportunity to play poker using a conventional video gaming machine. These video gaming machines generally operate in the following manner The player provides the ante by inserting money or tokens into the machine. The video gaming machine then randomly deals a hand of cards from a standard deck of fifty-two cards. The cards are randomly chosen by the processor and visually displayed to the player on a video display The player then draws by selecting which cards to discard. The video gaming machine then randomly deals the replacement cards from the remaining cards in the deck, and displays the replacement cards on the video display The payout provided by such conventional video gaming machines, if any, is generally determined by the content of the final hand. The final hand is compared against a predetermined table of odds for each possible winning hand combination of cards that is associated with a currency value.

While such conventional video gaming machines do provide a player with the opportunity to play conventional poker, they can fail to maintain the game at a level challenging enough to keep the player interested. There is a constant need in the gaming industry for new games that keep players interested, and substantially reduce the possibility that players will cease playing and wagering or reduce the amount of play and wagering due to lack of interest of challenge. Hence, conventional video gaming machines can fail to captivate the attention of the player, and therefore fail to maximize revenue for the casino. Many video gaining machines have been previously devised to overcome this problem by adding rules or procedures to the game of poker itself

For example, U.S. Pat. No. 5,366,228 to Kangsanaraks discloses a method for playing a card game, wherein the goal of the game is to acquire a hand having a total of 9 points. The Ace through 9 of each suit are counted at face value, and the ten, Jack, Queen, and King are counted as zero. The player can automatically win additional money if the player has a two or three-card flush. Two cards are initially dealt in the game, and the player can optionally draw a third card.

U.S. Pat. No. 4,651,997 to Wood discloses an “in between” type card game. In this game, two cards are drawn. A wager is then made on whether the next drawn card will fall within the range defined by the first two drawn cards. For example, if a 3 and 9 are drawn first, then the player can wager an amount that the next card will be a 4, 5, 6, 7, or 8 card.

Some video poker machines allow the player to play multiple hands of poker simultaneously. In one popular variation known as Triple Play®, the player receives three hands of poker The Triple Play® variations are covered in U.S. Pat. No. 5,823,873 issued to Moody. In one variation of this game, after receiving an initial hand of five cards the player can choose to select as few as zero and as many as all five of the cards as the cards to be held. All held cards from the initial hand immediately show up in the remaining two hands. When the player then selects the draw function, the video poker machine completes all three hands up to five cards, making a five-card hand in each of the three hands. Similar variations allow as many as 10 hands of poker to be played simultaneously in the same fashion.

Unfortunately, these games can complicate play with sophisticated concepts and rules, which are geared more towards players with extensive playing skills. Furthermore, these previously devised games require a great deal of time to complete a single round of play, which is not conducive to a casino environment.

In contrast to traditional games, the present invention moves along at a quick-pace and allows the player to complete a hand by picking an open-faced card from a selection of the remaining cards in the deck, thereby allowing the player to take note of each card picked up by the opposing players.

Therefore, it is a first object of the present invention to provide a novel twist that adds to the excitement of a traditional draw poker game.

It is a second object of the present invention to provide a game that is easy to play, and requires minimal knowledge of the workings of a traditional draw poker game.

It is a third object of the present invention to provide a playing card game that allows the players to bet or fold after each round in which a card is picked up from a selection of open-faced cards. The opportunity to increase the size of the pot in this manner will increase the interest of both new and experienced players.

Yet another object of the present invention is to provide a playing card game that can be implemented in a casino for gambling purposes.

### SUMMARY OF THE INVENTION

This invention relates generally to a card game wherein a player selects a new card from a group of open-faced cards to complete a hand. Preferably, the game is implemented in even rounds of card selection in order to allow the first player who selects a card in the initial round to be the final player to select a card in the subsequent round. In the most preferred embodiment, the card game follows the basic hand ranking of poker and is implemented in conjunction with a series of bets to increase the size of the pot and the players' excitement.

There are several different variations in which to play the present invention. One embodiment of the present invention encompasses a method of playing a card game comprising: dealing at least one card face-down to each player from a deck of cards, dividing the remaining cards of the deck into at least two piles; flipping a first pile of cards face-up and spreading them out so that all the cards may be viewed; allowing each player in turn to select a single card from the selection of face-up cards; flipping a second pile of cards face-up and spreading them out so that all the cards may be viewed; allowing each player in the reverse order to select a single card from the second selection of face-up cards, repeating the pile-flipping and card-selection steps until there are no more piles of cards, and comparing the hands of all players to determine the ranking of said hands.

A second method of playing a card game according to the rules of conventional draw poker which comprises: dealing at least one card face-down to each player from a deck of cards, dividing the remaining cards of the deck into at least two piles, flipping a first pile of cards face-up and spreading them out so that all the cards may be viewed; allowing each player in turn to select a single card from the selection of face-up cards; flipping a second pile of cards face-up and spreading them out so that all the cards may be viewed; allowing each player in the reverse order to select a single card from the second selection of face-up cards, repeating the pile-flipping and card-selection steps until there are no more piles of cards, and comparing the hands of all players to determine the ranking of said hands. In other words, the ranking of the hands with the highest values or poker ranks determines the order of the winners.

A third method of playing a card game comprises: dealing at least one card face-down to each player from a deck of cards; dividing the remaining cards of the deck into at least four piles, flipping a first pile of cards face-up and spreading them out so that all the cards may be viewed, allowing each player in turn to select a single card from the selection of face-up cards; flipping a second pile of cards face-up and spreading them out so that all the cards may be viewed; allowing each player in the reverse order to select a single card from the second selection of face-up cards; repeating the pile-flipping and card-selection steps until there are no more piles of cards; and comparing the hands of all players to determine the ranking of said hands.

A fourth method of playing a card game comprises. dealing at least one card face-down to each player from a deck of cards, dividing the remaining cards of the deck into at least six piles, flipping a first pile of cards face-up and spreading them out so that all the cards may be viewed; allowing each player in turn to select a single card from the selection of face-up cards, flipping a second pile of cards face-up and spreading them out so that all the cards may be viewed; allowing each player in the reverse order to select a single card from the second selection of face-up cards; repeating the pile-flipping and card-selection steps until there are no more piles of cards; and comparing the hands of all players to determine the ranking of said hands.

A fifth method of playing a card game comprises: dealing two cards face-down to each player from a deck of cards, dividing the remaining cards of the deck into at least two piles, flipping a first pile of cards face-up and spreading them out so that all the cards may be viewed; allowing each player in turn to select a single card from the selection of face-up cards; flipping a second pile of cards face-up and spreading them out so that all the cards may be viewed; allowing each player in the reverse order to select a single card from the second selection of face-up cards; repeating the pile-flipping and card-selection steps until there are no more piles of cards, and comparing the hands of all players to determine the ranking of said hands.

A sixth method of playing a card game comprises, dealing three cards face-down to each player from a deck of cards, dividing the remaining cards of the deck into at least two piles; flipping a first pile of cards face-up and spreading them out so that all the cards may be viewed; allowing each player in turn to select a single card from the selection of face-up cards; flipping a second pile of cards face-up and spreading them out so that all the cards may be viewed; allowing each player in the reverse order to select a single card from the second selection of face-up cards, repeating the pile-flipping and card-selection steps until there are no more piles of cards; and comparing the hands of all players to determine the ranking of said hands.

A seventh method of playing a card game comprises: dealing four cards face-down to each player from a deck of cards, dividing the remaining cards of the deck into at least two piles; flipping a first pile of cards face-up and spreading them out so that all the cards may be viewed, allowing each player in turn to select a single card from the selection of face-up cards, flipping a second pile of cards face-up and spreading them out so that all the cards may be viewed; allowing each player in the reverse order to select a single card from the second selection of face-up cards; repeating the pile-flipping and card-selection steps until there are no more piles of cards; and comparing the hands of all players to determine the ranking of said hands.

An eighth method of playing a card game comprises: dealing five cards face-down to each player from a deck of cards; dividing the remaining cards of the deck into at least two piles; flipping a first pile of cards face-up and spreading them out so that all the cards may be viewed, allowing each player in turn to select a single card from the selection of face-up cards; flipping a second pile of cards face-up and spreading them out so that all the cards may be viewed; allowing each player in the reverse order to select a single card from the second selection of face-up cards; repeating the pile-flipping and card-selection steps until there are no more piles of cards, and comparing the hands of all players to determine the ranking of said hands.

A ninth method of playing a card game comprises: all players submitting an ante; dealing at least one card face-down to each player from a deck of cards, dividing the remaining cards of the deck into at least two piles; flipping a first pile of cards face-up and spreading them out so that all the cards may be viewed; allowing each player in turn to select a single card from the selection of face-up cards; flipping a second pile of cards face-up and spreading them out so that all the cards may be viewed; allowing each player in the reverse order to select a single card from the second selection of face-up cards, repeating the pile-flipping and card-selection steps until there are no more piles of cards; and comparing the hands of all players to determine the ranking of said hands.

A tenth method of playing a card game comprises. dealing at least one card face-down to each player from a deck of cards, a round of betting wherein all players may pass, bet, raise the bet, match the bet, or fold; dividing the remaining cards of the deck into at least two piles, flipping a first pile of cards face-up and spreading them out so that all the cards may be viewed; allowing each player in turn to select a single card from the selection of face-up cards; flipping a second pile of cards face-up and spreading them out so that all the cards may be viewed, allowing each player in the reverse order to select a single card from the second selection of face-up cards, repeating the pile-flipping and card-selection steps until there are no more piles of cards; and comparing the hands of all players to determine the ranking of said hands.

An eleventh method of playing a card game comprises: dealing at least one card face-down to each player from a deck of cards; dividing the remaining cards of the deck into at least two piles, flipping a first pile of cards face-up and spreading them out so that all the cards may be viewed, allowing each player in turn to select a single card from the selection of face-up cards; a round of betting wherein all players may pass, bet, raise the bet, match the bet, or fold; flipping a second pile of cards face-up and spreading them out so that all the cards may be viewed; allowing each player in the reverse order to select a single card from the second selection of face-up cards; repeating the pile-flipping and card-selection steps until there are no more piles of cards; and comparing the hands of all players to determine the ranking of said hands. Furthermore, a round of betting, wherein all players may pass, bet, raise the bet, match the bet, or fold, is optional after each round of card selection by the players.

A twelfth method of playing a card game comprises. imposing a betting minimum and/or maximum on all players, dealing at least one card face-down to each player from a deck of cards, dividing the remaining cards of the deck into at least two piles, flipping a first pile of cards face-up and spreading them out so that all the cards may be viewed; allowing each player in turn to select a single card from the selection of face-up cards; flipping a second pile of cards face-up and spreading them out so that all the cards may be viewed; allowing each player in the reverse order to select a single card from the second selection of face-up cards, repeating the pile-flipping and card-selection steps until there are no more piles of cards; and comparing the hands of all players to determine the ranking of said hands. A round of betting, wherein all players may pass, bet, raise the bet, match the bet, or fold, is optional after the initial cards are dealt face down. Furthermore, a round of betting, wherein all players may pass, bet, raise the bet, match the bet, or fold, is optional after each round of card selection by the players.

A thirteenth method of playing a card game comprises. limiting the number of times a player may pass, bet, raise the bet, match the bet, and/or fold is imposed on all players, dealing at least one card face-down to each player from a deck of cards; dividing the remaining cards of the deck into at least two piles; flipping a first pile of cards face-up and spreading them out so that all the cards may be viewed; allowing each player in turn to select a single card from the selection of face-up cards, flipping a second pile of cards face-up and spreading them out so that all the cards may be viewed; allowing each player in the reverse order to select a single card from the second selection of face-up cards, repeating the pile-flipping and card-selection steps until there are no more piles of cards, and comparing the hands of all players to determine the ranking of said hands. A round of betting, wherein all players may pass, bet, raise the bet, match the bet, or fold, is optional after the cards are dealt face down. Furthermore, a round of betting, wherein all players may pass, bet, raise the bet, match the bet, or fold, is optional after each round of card selection by the players.

A fourteenth method of playing a card game comprises: dealing one card face-down to each player from a deck of cards; dividing the remaining cards of the deck into an even number of piles; flipping a first pile of cards face-up and spreading them out so that all the cards may be viewed; allowing each player in turn to select a single card from the selection of face-up cards; flipping a second pile of cards face-up and spreading them out so that all the cards may be viewed; allowing each player in the reverse order to select a single card from the second selection of face-up cards, repeating the pile-flipping and card-selection steps until there are no more piles of cards; and comparing the hands of all players to determine the ranking of said hands.

A fifteenth method of playing a card game comprises: dealing more than one card face-down to each player from a deck of cards; dividing the remaining cards of the deck into an even number of piles; flipping a first pile of cards face-up and spreading them out so that all the cards may be viewed; allowing each player in turn to select a single card from the selection of face-up cards, flipping a second pile of cards face-up and spreading them out so that all the cards may be viewed; allowing each player in the reverse order to select a single card from the second selection of face-up cards, repeating the pile-flipping and card-selection steps until there are no more piles of cards, and comparing the hands of all players to determine the ranking of said hands.

A sixteenth method of playing a card game comprises. all players submitting an ante; dealing one card face-down to each player from a deck of cards; dividing the remaining cards of the deck into an even number of piles, flipping a first pile of cards face-up and spreading them out so that all the cards may be viewed; allowing each player in turn to select a single card from the selection of face-up cards, flipping a second pile of cards face-up and spreading them out so that all the cards may be viewed; allowing each player in the reverse order to select a single card from the second selection of face-up cards; repeating the pile-flipping and card-selection steps until there are no more piles of cards, and comparing the hands of all players to determine the ranking of said hands.

A seventeenth method of playing a card game comprises. dealing one card face-down to each player from a deck of cards; a round of betting wherein all players may pass, bet, raise the bet, match the bet, or fold; dividing the remaining cards of the deck into an even number of piles, flipping a first pile of cards face-up and spreading them out so that all the cards may be viewed; allowing each player in turn to select a single card from the selection of face-up cards, flipping a second pile of cards face-up and spreading them out so that all the cards may be viewed; allowing each player in the reverse order to select a single card from the second selection of face-up cards; repeating the pile-flipping and card-selection steps until there are no more piles of cards; and comparing the hands of all players to determine the ranking of said hands.

An eighteenth method of playing a card game comprises. dealing one card face-down to each player from a deck of cards; dividing the remaining cards of the deck into an even number of piles; flipping a first pile of cards face-up and spreading them out so that all the cards may be viewed; allowing each player in turn to select a single card from the selection of face-up cards; a round of betting wherein all players may pass, bet, raise the bet, match the bet, or fold, flipping a second pile of cards face-up and spreading them out so that all the cards may be viewed; allowing each player in the reverse order to select a single card from the second selection of face-up cards, repeating the pile-flipping and card-selection steps until there are no more piles of cards; and comparing the hands of all players to determine the ranking of said hands. Furthermore, a round of betting, wherein all players may pass, bet, raise the bet, match the bet, or fold, is optional after each round of card selection by the players.

A nineteenth method of playing a card game comprises. imposing a betting minimum and/or maximum on all players; dealing one card face-down to each player from a deck of cards, dividing the remaining cards of the deck into an even number of piles; flipping a first pile of cards face-up and spreading them out so that all the cards may be viewed; allowing each player in turn to select a single card from the selection of face-up cards, flipping a second pile of cards face-up and spreading them out so that all the cards may be viewed; allowing each player in the reverse order to select a single card from the second selection of face-up cards; repeating the pile-flipping and card-selection steps until there are no more piles of cards; and comparing the hands of all players to determine the ranking of said hands. A round of betting, wherein all players may pass, bet, raise the bet, match the bet, or fold, is optional after the cards are dealt face down. Furthermore, a round of betting, wherein all players may pass, bet, raise the bet, match the bet, or fold, is optional after each round of card selection by the players.

A twentieth method of playing a card game comprises: limiting the number of times a player may pass, bet, raise the bet, match the bet, and/or fold is imposed on all players; dealing one card face-down to each player from a deck of cards; dividing the remaining cards of the deck into an even number of piles; flipping a first pile of cards face-up and spreading them out so that all the cards may be viewed, allowing each player in turn to select a single card from the selection of face-up cards, flipping a second pile of cards face-up and spreading them out so that all the cards may be viewed; allowing each player in the reverse order to select a single card from the second selection of face-up cards; repeating the pile-flipping and card-selection steps until there are no more piles of cards, and comparing the hands of all players to determine the ranking of said hands. A round of betting, wherein all players may pass, bet, raise the bet, match the bet, or fold, is optional after the cards are dealt face down. Furthermore, a round of betting, wherein all players may pass, bet, raise the bet, match the bet, or fold, is optional after each round of card selection by the players.

Yet another embodiment of the present invention encompasses a method of playing a card game according to the rules of conventional draw poker which comprises. dealing one card face-down to each player from a deck of cards, dividing the remaining cards of the deck into an even number of piles, flipping a first pile of cards face-up and spreading them out so that all the cards may be viewed; allowing each player in turn to select a single card from the selection of face-up cards, flipping a second pile of cards face-up and spreading them out so that all the cards may be viewed; allowing each player in the reverse order to select a single card from the second selection of face-up cards; repeating the pile-flipping and card-selection steps until there are no more piles of cards; and comparing the hands of all players to determine the ranking of said hands. In other words, the ranking of the hands with the highest values or poker ranks determines the order of the winners.

### BRIEF DESCRIPTION OF THE DRAWINGS

While the disclosure concludes with claims particularly pointing out and distinctly claiming embodiments within the scope of the disclosure, various features and advantages of embodiments encompassed by the disclosure may be more readily ascertained from the following description when read in conjunction with the accompanying drawings, in which:

FIG. 1 represents the first step in a card game in which three players, Players A, B, and C, are each dealt three cards and the remaining cards in the deck are split into two piles, Pile 1 and Pile 2, according to one specific embodiment of the present disclosure.

FIG. 2 represents the second step in the aforementioned card game, wherein Pile 1 is turned over to face-up and spread out so that all the cards may be viewed.

FIG. 3 represents the third step in the aforementioned card game, wherein the first player to select a card from Pile 1 is Player A.

FIG. 4 represents the fourth step in the aforementioned card game, wherein the second player to select a card from Pile 1 is Player B

FIG. 5 represents the fifth step in the aforementioned card game, wherein the third player to select a card from Pile 1 is Player C.

FIG. 6 represents the sixth step in the aforementioned card game, wherein the unselected cards from Pile 1 are flipped face down and moved to a Dead Pile; and Pile 2 is turned over to face-up and spread out so that all the cards may be viewed.

FIG. 7 represents the seventh step in the aforementioned card game, wherein the first player to select a card from Pile 2 is Player C.

FIG. 8 represents the eighth step in the aforementioned card game, wherein the second player to select a card from Pile 2 is Player B.

FIG. 9 represents the ninth step in the aforementioned card game, wherein the third player to select a card from Pile 2 is Player A.

FIG. 10 represents the tenth step in the aforementioned card game, wherein the unselected cards from Pile 2 are flipped face down and moved to the Dead Pile; and Players A, B, and C have flipped over their respective face down cards to reveal their complete five-card poker hand.

### WRITTEN DESCRIPTION OF THE INVENTION

While this invention is susceptible of embodiment in many different forms, there is shown in the drawings and will herein be described in detail, one or more specific embodiments, with the understanding that the present disclosure is to be considered merely an exemplification of the principles of the invention and is not intended to limit the invention only to the embodiments described and illustrated.

Any patent, patent application or other document referred to herein is incorporated by reference into this patent application as part of the present disclosure, but only for purposes of written description and enablement in accordance with 35 U S.C. § 112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference. Conversely, the definitions provided in this application should not be used to limit, define, or otherwise construe any term of any document incorporated herein by reference. The definitions set forth explicitly in this application are controlling notwithstanding the description of particular embodiments that may be incompatible with the definition(s). Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

The game of the present invention can be played on a conventional playing card table or any electronic computing device. The game is most preferably played in a casino for gambling purposes. Alternatively, it can be played on a computing device (i.e. a desktop computer or PC, a laptop or other portable computer, a cellular phone, a personal digital assistant or PDA, or other such computing devices) as an on-line game over the Internet as part of a Wide Area Network (“WAN”), as part of a Local Area Network (“LAN”), a wireless LAN (“WLAN”) and/or a stand-alone computing device.

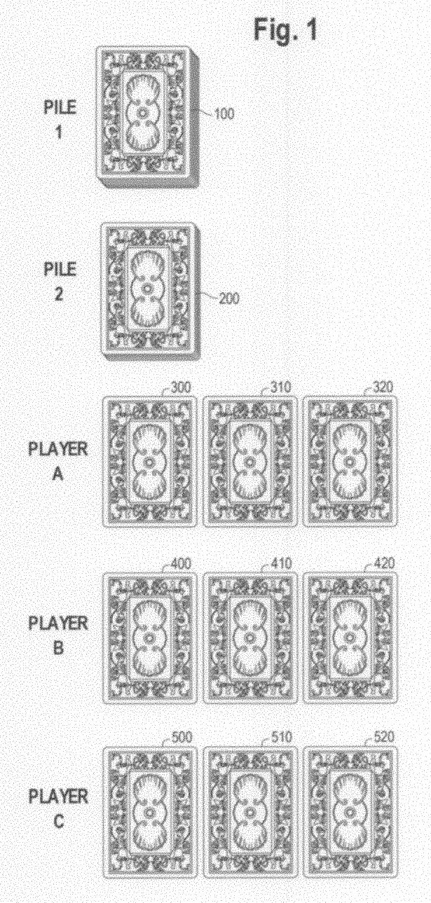

FIG. 1 is a representative of one embodiment of the present invention in which three players are dealt three cards face down and the remaining cards in the deck are divided into two piles. Player A is dealt cards 300, 310, and 320 face down. Player B is dealt cards 400, 410, and 420 face down. Player C is dealt cards 500, 510, and 520 face down. The remaining cards in the deck are divided into a first pile, Pile 1 100, and a second pile, Pile 2 200.

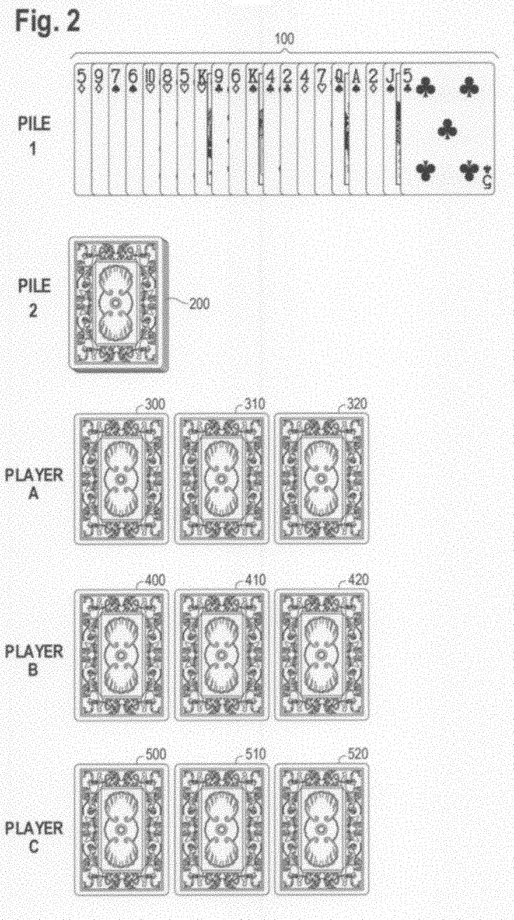

FIG. 2 is the second step of the aforementioned embodiment in which Pile 1 100 is flipped over to be face up, and spread out so that all of the cards may be viewed by all of the players. Pile 2 200 remains face down. Player A can look at cards 300, 310, and 320, but the remaining players are not allowed to view them. Player B can look at cards 400, 410, and 420, but the remaining players are not allowed to view them. Player C can look at cards 500, 510, and 520, but the remaining players are not allowed to view them. For the purposes of this illustration, cards 300, 310, 320, 400, 410, 420, 500, 510, and 520 remain face down and are only known to the player holding those cards.

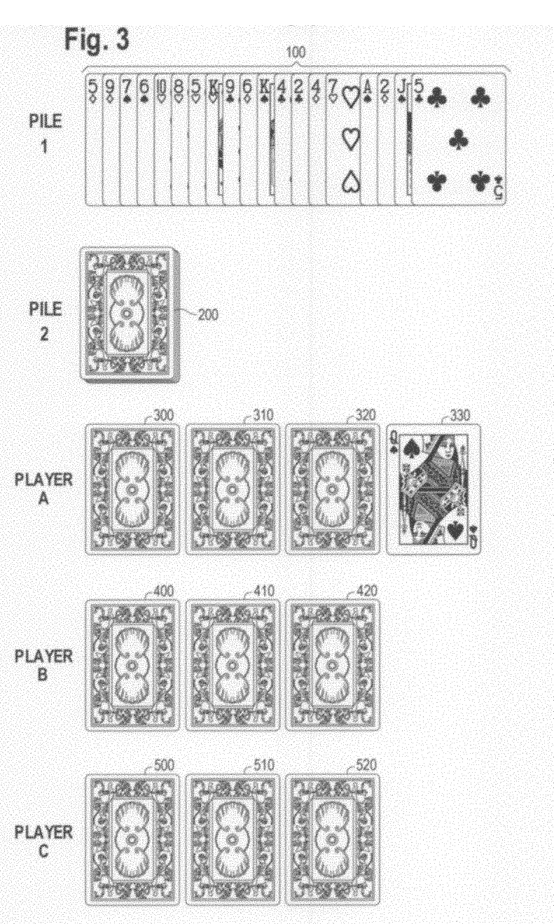

FIG. 3 is the third step in the aforementioned embodiment in which Player A chose one card 330 from Pile 1 100. Any card that is picked from Pile 1 100 remains face up, such as the card 330 chosen by Player A. Pile 2 200 remains face down. For the purposes of this illustration, cards 300, 310, 320, 400, 410, 420, 500, 510, and 520 remain face down and are only known to the player holding those cards.

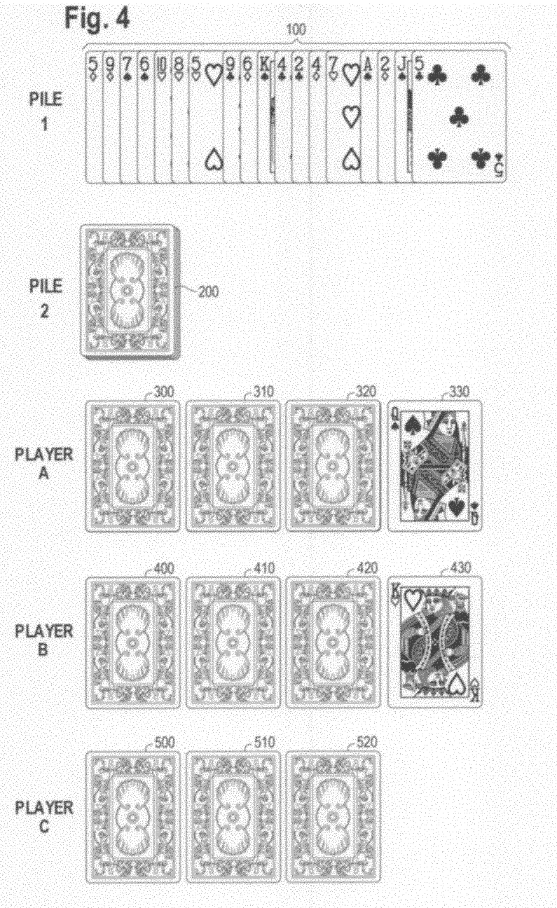

FIG. 4 is the fourth step in the aforementioned embodiment in which Player B chose one card 430 from Pile 1 100. Any card that is picked from Pile 1 100 remains face up, such as the card 430 selected by Player B, and the card 330 selected by Player A. Pile 2 200 remains face down. For the purposes of this illustration, cards 300, 310, 320, 400, 410, 420, 500, 510, and 520 remain face down and are only known to the player holding those cards.

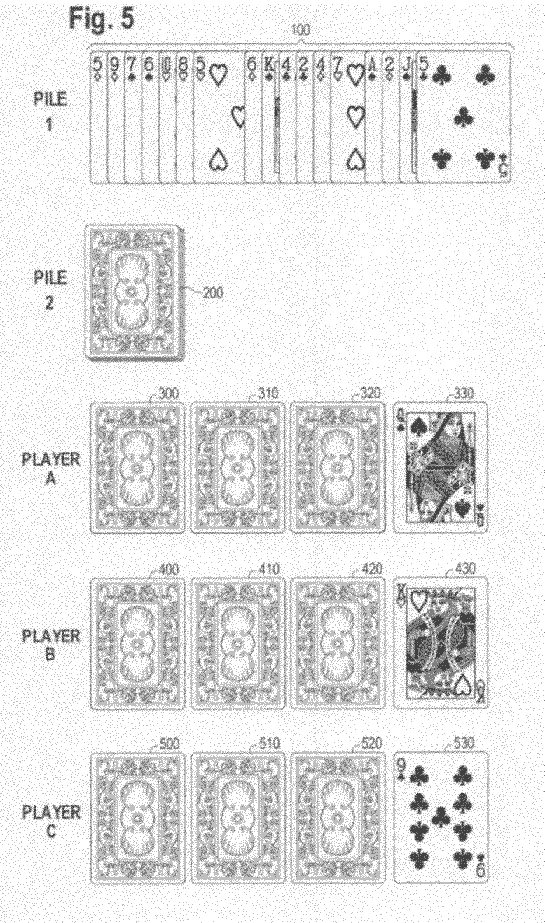

FIG. 5 is the fifth step in the aforementioned embodiment in which Player C chose one card 530 from Pile 1 100. Any card that is picked from Pile 1 100 remains face up, such as the card 530 chosen by Player C, the card 430 selected by Player B, and the card 330 selected by Player A. Pile 2 200 remains face down. For the purposes of this illustration, cards 300, 310, 320, 400, 410, 420, 500, 510, and 520 remain face down and are only known to the player holding those cards.

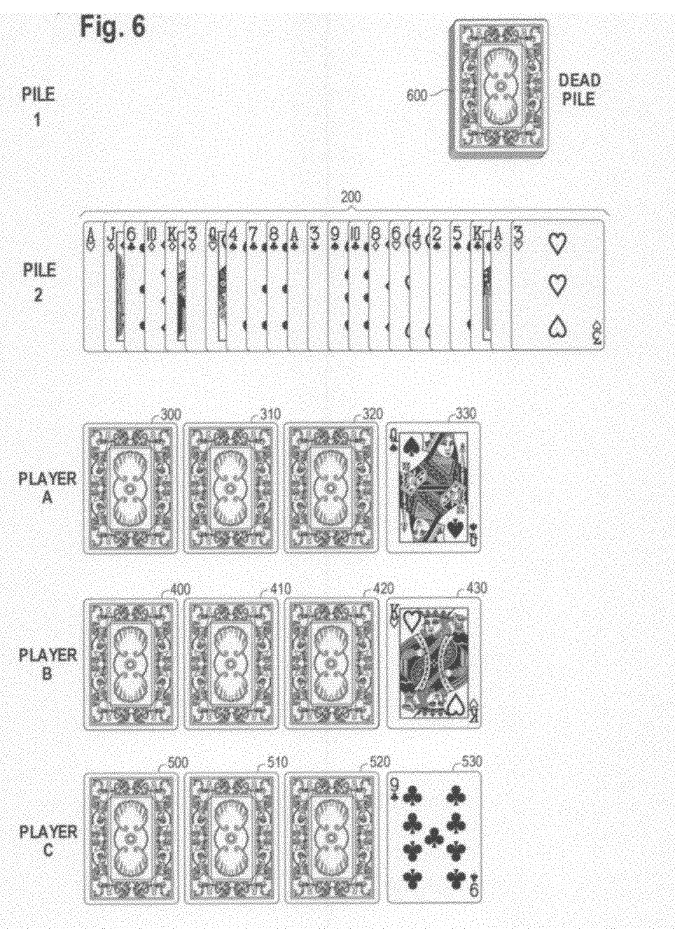

FIG. 6 is the sixth step in the aforementioned embodiment in which the unselected cards from Pile 1 are flipped face down and moved to the Dead Pile 600. Pile 2 200 is flipped face up and spread out so that all of the cards may be viewed by all of the players. The cards 330, 430, and 530 selected from Pile 1 remain face up. For the purposes of this illustration, cards 300, 310, 320, 400, 410, 420, 500, 510, and 520 remain face down and are only known to the player holding those cards.

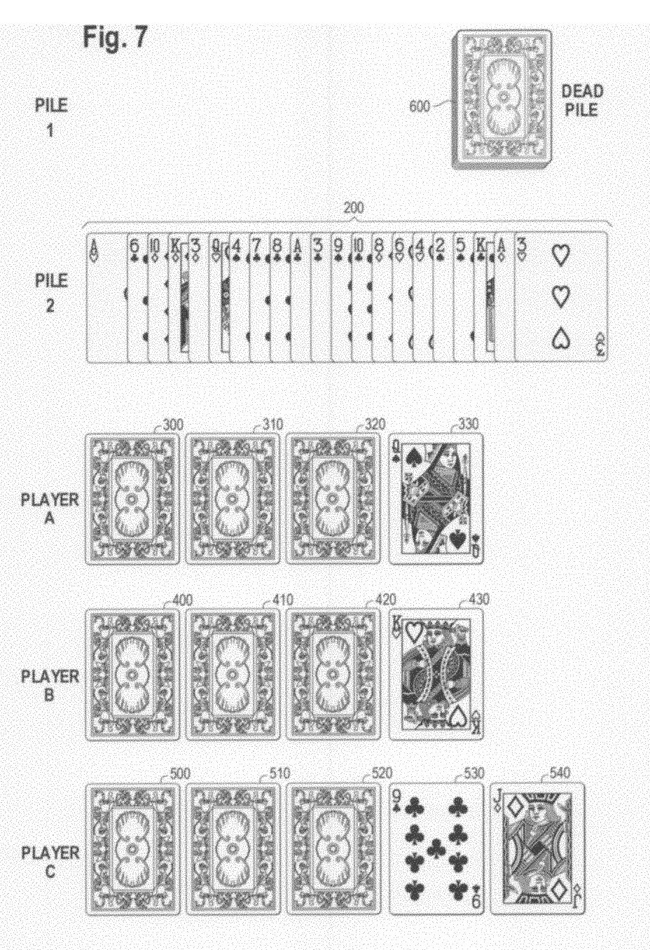

FIG. 7 is the seventh step in the aforementioned embodiment. It is important to note that the order of card selection has been reversed. The last player to select a card in the first round, Player C, is now the first player to select a card in the second round. Player C selected the card 540 from Pile 2 200. The cards 330, 430, and 530 selected from Pile 1 remain face up. The Dead Pile 600 remains face down. For the purposes of this illustration, cards 300, 310, 320, 400, 410, 420, 500, 510, and 520 remain face down and are only known to the player holding those cards.

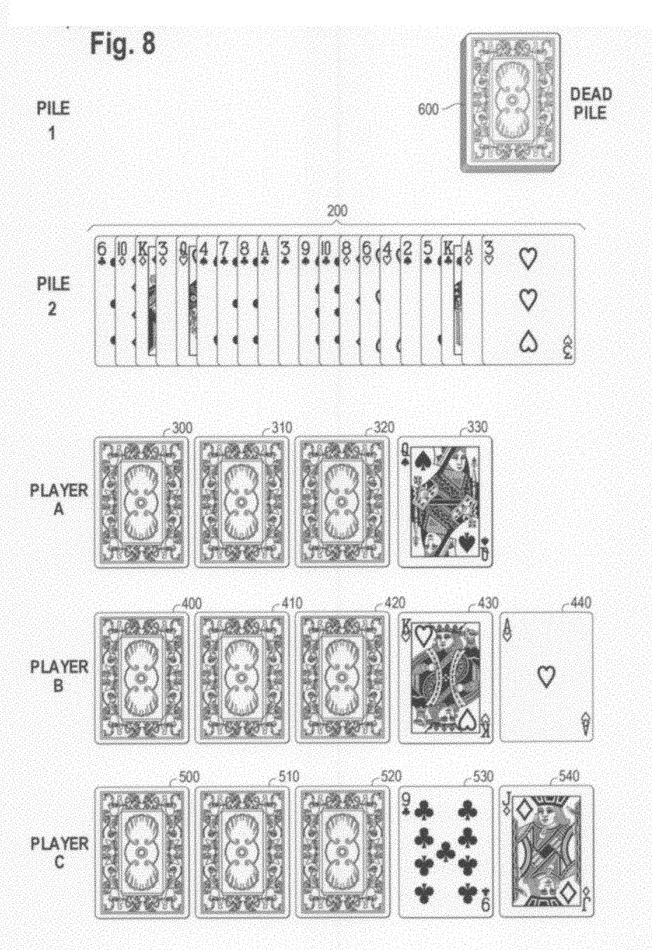

FIG. 8 is the eighth step in the aforementioned embodiment. Even though the order of selection has been reversed in the second round, Player B is the second player to choose a card 440 from Pile 2 200. The cards 330, 430, and 530 selected from Pile 1, as well as the card 540 selected from Pile 2 200, remain face up. The Dead Pile 600 remains face down. For the purposes of this illustration, cards 300, 310, 320, 400, 410, 420, 500, 510, and 520 remain face down and are only known to the player holding those cards.

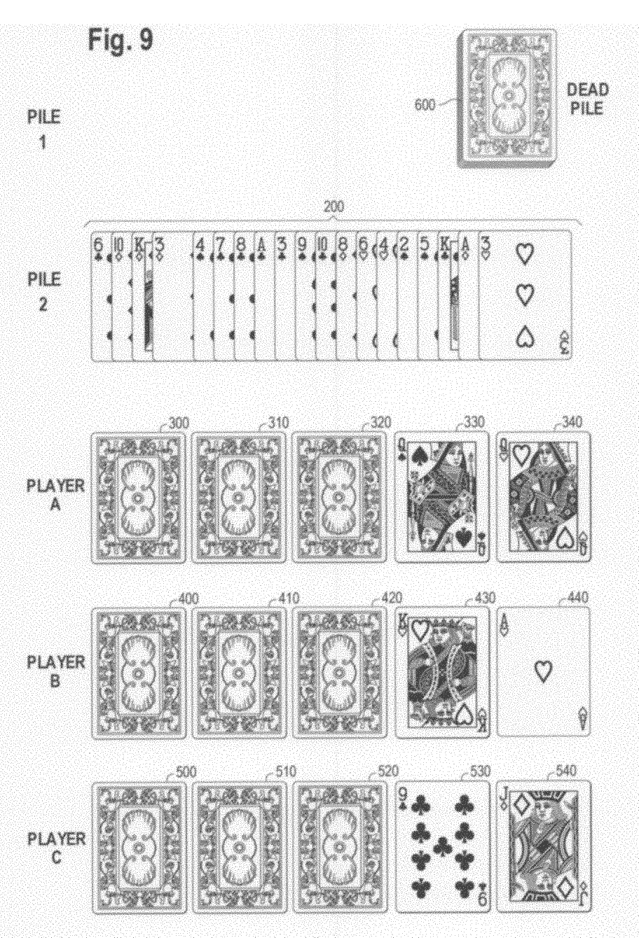

FIG. 9 is the ninth step in the aforementioned embodiment. The first player to select a card in the first round, Player A, is now the last player to select a card in the second round. Player A selected the card 340 from Pile 2 200. The cards 330, 430, and 530 selected from Pile 1, as well as the cards 540 and 440 selected from Pile 2 200, remain face up. The Dead Pile 600 remains face down. For the purposes of this illustration, cards 300, 310, 320, 400, 410, 420, 500, 510, and 520 remain face down and are only known to the player holding those cards.

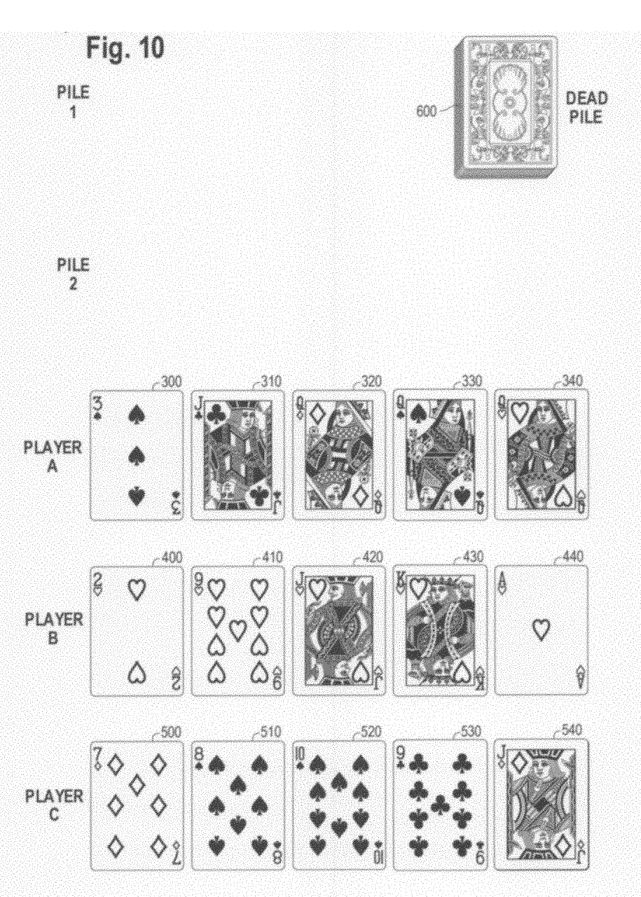

FIG. 10 is the final step in the aforementioned embodiment in which the unselected cards from Pile 2 are flipped face down and added to the Dead Pile 600. All players have flipped all of their cards face up and compare their respective hands to determine the winner Player B reveals the winning hand with a Flush because her cards 400, 410, 420, 430, and 440 are composed of a single suit. Player C has the second-best hand because his cards 500, 510, 520, 530, and 540 reveal a Straight Player A has the third-best hand because her cards 300, 310, 320, 330, and 340 only reveal Three-Of-A-Kind. According to conventional poker rules, a Flush beats a Straight, and both beat Three-Of-A-Kind.

The basic rules of this invention can be extrapolated to encompass various embodiments. In one example of the invention, a card game is played with a hand of five cards wherein the highest-ranking hand per conventional poker rules wins. For example, the dealer deals one card face down to each player The remaining unused cards in the deck are then separated into four piles faced-down in front of the dealer. A minimum number of cards must be present in each pile to equal the number of players. Pile 1 is then turned over to face-up and spread out so all the cards may be viewed. Moving left-to-right from the perspective of the dealer, each player will choose one card from the selection of face-up cards. Every card chosen by a player will remain faced-up in front of the player who selected it. After each player has selected a card, the dealer then collects the unselected cards and turns them face down into a “dead pile.” These cards are now dead to the game and cannot be used or viewed. The dealer then turns over Pile 2 of cards and spreads them out in full view Moving right-to-left from the perspective of the dealer, each player will choose one card from the second selection of face-up cards. In other words, the last player to choose in the initial round now gets to choose first in the subsequent round because the order of selection is reversed. After each player has chosen one card from the second selection of face-up cards, the remaining cards are flipped face down and added to the dead pile. The dealer then turns over the third pile of cards faced-up and spreads them out in full view Moving left-to-right from the perspective of the dealer, each player will choose one card from the third selection of face-up cards. In other words, the order of selection has reversed again to imitate the first round of selection. The dealer then collects the unselected cards from the third selection of face-up cards, flips them face down, and adds them to the dead pile. The dealer then turns over the fourth and final pile of cards, and spreads them out in full view. Moving right-to-left from the perspective of the dealer, each player will choose one card from the fourth selection of face-up cards. In other words, the order of selection has reversed again to imitate the second round of selection. The unselected cards from the fourth selection of faced-up cards are flipped face down and placed in the dead pile. Each player should now have five cards, one faced-down and four faced-up. Whoever has the highest-ranking poker hand wins.

In a second example of the invention, a card game is played with a hand of five cards wherein the highest-ranking hand per conventional poker rules wins. In this embodiment, the dealer deals three cards face down to each player. The remaining unused cards in the deck are then separated into two piles faced-down in front of the dealer A minimum number of cards must be present in each pile to equal the number of players. Pile 1 is then turned over to face-up and spread out so all the cards may be viewed. Moving left-to-right from the perspective of the dealer, each player will choose one card from the selection of face-up cards. Every card chosen by a player will remain faced-up in front of the player who selected it. After each player has selected a card, the dealer then collects the unselected cards and turns them face down into a dead pile. The dealer then turns over Pile 2 of cards and spreads them out in full view Moving right-to-left from the perspective of the dealer, each player will choose one card from the second selection of face-up cards. In other words, the last player to choose in the initial round now gets to choose first in the subsequent round because the order of selection is reversed. After each player has chosen one card from the second selection of face-up cards, the remaining cards are flipped face down and added to the dead pile. Each player should now have five cards, three faced-down and two faced-up. Whoever has the highest-ranking poker hand wins.

In a third example of the invention, a card game is played with a hand of six cards wherein the highest-ranking hand per conventional poker rules wins. In this embodiment, the dealer deals two cards face down to each player The remaining unused cards in the deck are then separated into four piles faced-down in front of the dealer A minimum number of cards must be present in each pile to equal the number of players. Pile 1 is then turned over to face-up and spread out so all the cards may be viewed. Moving left-to-right from the perspective of the dealer, each player will choose one card from the selection of face-up cards. Every card chosen by a player will remain faced-up in front of the player who selected it. After each player has selected a card, the dealer then collects the unselected cards and turns them face down into a dead pile. The dealer then turns over Pile 2 of cards and spreads them out in full view Moving right-to-left from the perspective of the dealer, each player will choose one card from the second selection of face-up cards. In other words, the last player to choose in the initial round now gets to choose first in the subsequent round because the order of selection is reversed. After each player has chosen one card from the second selection of face-up cards, the remaining cards are flipped face down and added to the dead pile. The dealer then turns over the third pile of cards faced-up and spreads them out in full view. Moving left-to-right from the perspective of the dealer, each player will choose one card from the third selection of face-up cards. In other words, the order of selection has reversed again to imitate the first round of selection. The dealer then collects the unselected cards from the third selection of face-up cards, flips them face down, and adds them to the dead pile. The dealer then turns over the fourth and final pile of cards, and spreads them out in full view Moving right-to-left from the perspective of the dealer, each player will choose one card from the fourth selection of face-up cards. In other words, the order of selection has reversed again to imitate the second round of selection. The unselected cards from the fourth selection of faced-up cards are flipped face down and placed in the dead pile. Each player should now have six cards, two faced-down and four faced-up. Whoever has the highest-ranking poker hand wins.

In a fourth example of the invention, a card game is played with a hand of six cards wherein the highest-ranking hand per conventional poker rules wins. In this embodiment, the dealer deals four cards face down to each player. The remaining unused cards in the deck are then separated into two piles faced-down in front of the dealer A minimum number of cards must be present in each pile to equal the number of players. Pile 1 is then turned over to face-up and spread out so all the cards may be viewed. Moving left-to-right from the perspective of the dealer, each player will choose one card from the selection of face-up cards. Every card chosen by a player will remain faced-up in front of the player who selected it. After each player has selected a card, the dealer then collects the unselected cards and turns them face down into a dead pile. The dealer then turns over Pile 2 of cards and spreads them out in full view Moving right-to-left from the perspective of the dealer, each player will choose one card from the second selection of face-up cards. In other words, the last player to choose in the initial round now gets to choose first in the subsequent round because the order of selection is reversed. After each player has chosen one card from the second selection of face-up cards, the remaining cards are flipped face down and added to the dead pile. Each player should now have six cards, four faced-down and two faced-up. Whoever has the highest-ranking poker hand wins.

In a fifth example of the invention, a card game is played with a hand of seven cards wherein the highest-ranking hand per conventional poker rules wins. In this embodiment, the dealer deals one card face down to each player. The remaining unused cards in the deck are then separated into six piles faced-down in front of the dealer. A minimum number of cards must be present in each pile to equal the number of players. Pile 1 is then turned over to face-up and spread out so all the cards may be viewed. Moving left-to-right from the perspective of the dealer, each player will choose one card from the selection of face-up cards. Every card chosen by a player will remain faced-up in front of the player who selected it. After each player has selected a card, the dealer then collects the unselected cards and turns them face down into a dead pile. The dealer then turns over Pile 2 of cards and spreads them out in full view Moving right-to-left from the perspective of the dealer, each player will choose one card from the second selection of face-up cards. In other words, the last player to choose in the initial round now gets to choose first in the subsequent round because the order of selection is reversed. After each player has chosen one card from the second selection of face-up cards, the remaining cards are flipped face down and added to the dead pile. The dealer then turns over the third pile of cards faced-up and spreads them out in full view Moving left-to-right from the perspective of the dealer, each player will choose one card from the third selection of face-up cards. In other words, the order of selection has reversed again to imitate the first round of selection. The dealer then collects the unselected cards from the third selection of face-up cards, flips them face down, and adds them to the dead pile. The dealer then turns over the fourth pile of cards, and spreads them out in full view. Moving right-to-left from the perspective of the dealer, each player will choose one card from the fourth selection of face-up cards. In other words, the order of selection has reversed again to imitate the second round of selection. The unselected cards from the fourth selection of faced-up cards are flipped face down and placed in the dead pile. The dealer then turns over the fifth pile of cards faced-up and spreads them out in full view Moving left-to-right from the perspective of the dealer, each player will choose one card from the fifth selection of face-up cards. In other words, the order of selection has reversed again to imitate the first round of selection. The dealer then collects the unselected cards from the fifth selection of face-up cards, flips them face down, and adds them to the dead pile. The dealer then turns over the sixth and final pile of cards, and spreads them out in full view Moving right-to-left from the perspective of the dealer, each player will choose one card from the fourth selection of face-up cards. In other words, the order of selection has reversed again to imitate the second round of selection. The unselected cards from the sixth selection of faced-up cards are flipped face down and placed in the dead pile. Each player should now have seven cards, one faced-down and six faced-up. Whoever has the highest-ranking poker hand wins.

In a sixth example of the invention, a card game is played with a hand of seven cards wherein the highest-ranking hand per conventional poker rules wins. In this embodiment, the dealer deals three cards face down to each player. The remaining unused cards in the deck are then separated into four piles faced-down in front of the dealer. A minimum number of cards must be present in each pile to equal the number of players. Pile 1 is then turned over to face-up and spread out so all the cards may be viewed. Moving left-to-right from the perspective of the dealer, each player will choose one card from the selection of face-up cards. Every card chosen by a player will remain faced-up in front of the player who selected it. After each player has selected a card, the dealer then collects the unselected cards and turns them face down into a dead pile. The dealer then turns over Pile 2 of cards and spreads them out in full view Moving right-to-left from the perspective of the dealer, each player will choose one card from the second selection of face-up cards. In other words, the last player to choose in the initial round now gets to choose first in the subsequent round because the order of selection is reversed. After each player has chosen one card from the second selection of face-up cards, the remaining cards are flipped face down and added to the dead pile. The dealer then turns over the third pile of cards faced-up and spreads them out in full view. Moving left-to-right from the perspective of the dealer, each player will choose one card from the third selection of face-up cards. In other words, the order of selection has reversed again to imitate the first round of selection. The dealer then collects the unselected cards from the third selection of face-up cards, flips them face down, and adds them to the dead pile. The dealer then turns over the fourth and final pile of cards, and spreads them out in full view. Moving right-to-left from the perspective of the dealer, each player will choose one card from the fourth selection of face-up cards. In other words, the order of selection has reversed again to imitate the second round of selection. The unselected cards from the fourth selection of faced-up cards are flipped face down and placed in the dead pile. Each player should now have seven cards, three faced-down and four faced-up. Whoever has the highest-ranking poker hand wins.

In a seventh example of the invention, a card game is played with a hand of seven cards wherein the highest-ranking hand per conventional poker rules wins. In this embodiment, the dealer deals five cards face down to each player. The remaining unused cards in the deck are then separated into two piles faced-down in front of the dealer A minimum number of cards must be present in each pile to equal the number of players. Pile 1 is then turned over to face-up and spread out so all the cards may be viewed. Moving left-to-right from the perspective of the dealer, each player will choose one card from the selection of face-up cards. Every card chosen by a player will remain faced-up in front of the player who selected it. After each player has selected a card, the dealer then collects the unselected cards and turns them face down into a dead pile. The dealer then turns over Pile 2 of cards and spreads them out in full view. Moving right-to-left from the perspective of the dealer, each player will choose one card from the second selection of face-up cards. In other words, the last player to choose in the initial round now gets to choose first in the subsequent round because the order of selection is reversed. After each player has chosen one card from the second selection of face-up cards, the remaining cards are flipped face down and added to the dead pile. Each player should now have seven cards, five faced-down and two faced-up. Whoever has the highest-ranking poker hand wins.

Various elements can be added to these examples by incorporating the act of wagering on the outcome of the game. For example, each player may place a bet of a predetermined amount, or ante, before any cards are dealt. The ante is basically an entrance fee for each player to receive an initial hand of cards. This single bet may constitute the entirety of all wagers in a single round of play

In addition to the ante, or in lieu of the ante, an optional round of betting can be incorporated after the face down cards have been dealt. This round of betting may take place before or after the players inspect their face down cards. A typical round of betting can involve an initial player who chooses not to bet, followed by a player (either moving left-to-right or right-to-left from the perspective of the dealer) who chooses to place a bet, followed by a third player who must match the bet or fold, etc. until every player has either matched the bet or folded. There are a number of reasons as to why a player may want to pass, bet, raise the bet, match the bet, or fold his or her hand after viewing the face down cards. In addition, there are a number of reasons as to why a player may want to pass, bet, raise the bet, match the bet, or fold after witnessing another player's willingness to pass, bet, raise the bet, match the bet, or fold.

Another optional round of betting can be incorporated after the dealer clears away unselected cards into the dead pile. Based on the specific embodiment of the present invention at play, the game could offer multiple rounds of betting based purely on the number of rounds required for the players to select a card and complete their hands.

Furthermore, the rules of wagering may vary In one embodiment, betting limits may be incorporated into the game. For example, a minimum or a maximum ante may be imposed. In another example, a betting limit may place a minimum or a maximum on the amount of money that is wagered per round. Another embodiment may place a minimum or a maximum on the amount a bet may be raised. In another embodiment, a limit may be placed on the number of times a bet is raised in a single round of wagering.

Numerous embodiments and examples are described in the present application, and are presented for illustrative purposes only The words “embodiment” and “example” can be used interchangeably, as can the definitions of each word. The described embodiments are not, and are not intended to be, limiting in any sense. The disclosed invention is widely applicable to numerous embodiments, as is readily apparent from the disclosure. One of ordinary skill in the art will recognize that the disclosed invention may be practiced with various modifications and alterations, such as structural, logical, software, and electrical modifications. Although particular features of the disclosed invention may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not be interpreted as requiring features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or (with respect to a claim and the invention defined by that claim) expressly recited in that claim.

Any preambles of the claims that recite anything other than a statutory class shall be interpreted to recite purposes, benefits and possible uses of the claimed invention, and such preambles shall not be construed to limit the claimed invention.

The present disclosure is not a literal description of all embodiments of the invention. Also, the present disclosure is not a listing of features of the invention that must be present in all embodiments.

All disclosed embodiments are not necessarily covered by the claims (even including all pending, amended, issued and canceled claims). In addition, a disclosed embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

The invention claimed is:

1. A method of playing a card game comprising:
dealing at least one card face-down to each player from a deck of cards, dividing the remaining cards of the deck into at least two piles;
flipping a first pile of cards face-up and spreading them out so that all the cards may be viewed;
allowing each player in turn to select a single card from the selection of face-up cards,
flipping a second pile of cards face-up and spreading them out so that all the cards may be viewed;
allowing each player in the reverse order to select a single card from the second selection of face-up cards,
repeating the pile-flipping and card-selection steps until there are no more piles of cards; and
comparing the hands of all players to determine the ranking of said hands.

2. The method of claim 1, in which the card game is draw poker

3. The method of claim 1, in which the remaining cards of the deck are divided into four piles.

4. The method of claim 1, in which the remaining cards of the deck are divided into six piles.

5. The method of claim 1, in which two cards are dealt faced-down.

6. The method of claim 1, in which three cards are dealt faced-down.

7. The method of claim 1, in which four cards are dealt faced-down.

8. The method of claim 1, in which five cards are dealt faced-down.

9. The method of claim 1, in which all players submit an ante prior to dealing at least one card face-down to each player from a deck of cards.

10. The method of claim 1, in which all players may pass, bet, raise the bet, match the bet, or fold after the face-down cards have been dealt.

11. The method of claim 1, in which all players may pass, bet, raise the bet, match the bet, or fold after at least one round of open-faced card selection.

12. The method of claim 1, in which a betting minimum and/or maximum is imposed on all players.

13. The method of claim 1, in which a limited number of times a player may pass, bet, raise the bet, match the bet, and/or fold is imposed on all players.

14. A method of playing a card game comprising:
dealing one card face-down to each player from a deck of cards,
dividing the remaining cards of the deck into an even number of piles;
flipping a first pile of cards face-up and spreading them out so that all the cards may be viewed;
allowing each player in turn to select a single card from the selection of face-up cards;
flipping a second pile of cards face-up and spreading them out so that all the cards may be viewed;
allowing each player in the reverse order to select a single card from the second selection of face-up cards,
repeating the pile-flipping and card-selection steps until there are no more piles of cards; and
comparing the hands of all players to determine the ranking of said hands.

15. The method of claim 14, in which more than one card is dealt faced-down.

16. The method of claim 14, in which all players submit an ante prior to dealing at least one card face-down to each player from a deck of cards.

17. The method of claim 14, in which all players may pass, bet, raise the bet, match the bet, or fold after the face-down cards have been dealt.

18. The method of claim 14, in which all players may pass, bet, raise the bet, match the bet, or fold after at least one round of open-faced card selection.

19. The method of claim 14, in which a betting minimum and/or maximum is imposed on all players.

20. The method of claim 14, in which a limited number of times a player may pass, bet, raise the bet, match the bet, and/or fold is imposed on all players.
